(19) United States
(12) Patent Application Publication
(10) Pub. No.: US 2012/0020726 A1
(43) Pub. Date: Jan. 26, 2012

(54) RETAINING MODULE AND COMPONENT ASSEMBLY HAVING THE SAME

(76) Inventor: Bin-Hern JAN, New Taipei City (TW)

(21) Appl. No.: 13/024,489

(22) Filed: Feb. 10, 2011

(30) Foreign Application Priority Data
Jul. 21, 2010 (TW) 099213917

(51) Int. Cl. F16B 5/06

(52) U.S. Cl. 403/327; 403/330

(57) ABSTRACT

A component assembly includes a retaining module and a component. The component has a surface and two first engaging portions disposed at the surface. The retaining module includes a pair of engaging arms and a resilient member. Each of the engaging arms has an upright elongate arm body, a second engaging portion disposed at a bottom end of the arm body, and a head portion disposed at a top end of the arm body. The second engaging portions of the engaging arms engage respectively the first engaging portions of the component so as to connect the engaging arms with the component. The engaging arms are adapted to extend through a hole in a connecting member, and are convertible between a locking stat and a release state. The resilient member biases the engaging arms into the locking state.

### BACKGROUND OF THE INVENTION

### CROSS REFERENCE TO RELATED APPLICATION

This application claims priority of Taiwanese application no. 099213917, filed on Jul. 21, 2010.

1. Field of the Invention

The invention relates to a retaining module, more particularly to a retaining module that is adapted for interconnecting two members removably.

2. Description of the Related Art

Conventionally, two members are interconnected removably by bolts, tongue-and-groove engagements, glues, or other similar retaining means. In case of tongue-and-groove engagements, typically, one of the members is formed with an engaging groove or an engaging hole, and the other one of the members is provided with an engaging tongue or an engaging hook. However, such a tongue-and-groove arrangement has a disadvantage. That is, when the engaging tongue or the engaging hook is deformed, broken, or fractured, both of the two members are not reusable, and thus need to be replaced, thereby increasing the replacement cost.

### SUMMARY OF THE INVENTION

Therefore, the main object of the present invention is to provide a retaining module that interconnects two members removably such that, when the retaining module is damaged to an extent that it is not reusable, all that is needed for replacement is only the retaining module, thereby reducing the replacement cost.

According to one aspect of the present invention, there is provided a retaining module that is adapted for connection with a component and adapted to permit a connecting member to be sleeved thereon, so as to connect the connecting member to the component, wherein the connecting member has a hole formed therethrough, and the component has a pair of first engaging portions. The retaining module comprises a pair of engaging arms and a resilient member. Each of the engaging arms has an upright elongate arm body, a second engaging portion disposed at a bottom end of the arm body, and a head portion disposed at a top end of the arm body. The second engaging portions of the engaging arms engage respectively the first engaging portions of the component so as to connect the engaging arms with the component. The engaging arms are adapted to extend through the hole in the connecting member, and are convertible between a locking state, where the connecting member is confined between the component and the head portions of the engaging arms, and a release state, where the head portions of the engaging arms are movable through the hole in the connecting member and where removal of the head portions from the connecting member is allowed. The resilient member is disposed between the engaging arms for biasing the engaging arms into the locking state.

According to another aspect of the present invention, there is provided a component assembly that comprises a component and a retaining module and that is adapted to connect with a connecting member that has a hole formed therethrough so as to be sleeved on the component assembly. The component has a surface and a pair of first engaging portions disposed at the surface of the component. The retaining module includes a pair of engaging arms and a resilient member. Each of the engaging arms has an upright elongate arm body, a second engaging portion disposed at a bottom end of the arm body, and a head portion disposed at a top end of the arm body. The second engaging portions of the engaging arms engage respectively the first engaging portions of the component so as to connect the engaging arms with the component. The engaging arms are adapted to extend through the hole in the connecting member, and are convertible between a locking state, where the connecting member is confined between the component and the head portions of the engaging arms, and a release state, where the head portions of the engaging arms are movable through the hole in the connecting member and where removal of the head portions from the connecting member is allowed. The resilient member is disposed between the engaging arms for biasing the engaging arms into the locking state.

As such, the connecting member is connected to the component by the retaining module. When damage is caused to the retaining module to an extent that the retaining module is not reusable, all that is needed for replacement is only the retaining module. In other words, it is not necessary to replace the connecting member and the component, thereby reducing the replacement cost significantly.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled perspective view of the preferred embodiment of a component assembly according to the present invention;

FIG. 2 is an exploded perspective view of the preferred embodiment;

FIG. 3 is a sectional view of a component of the preferred embodiment;

FIG. 4 is a sectional view for illustrating a retaining module of the preferred embodiment;

FIG. 5 is a sectional view similar to FIG. 4, viewed at another angle;

FIG. 6 is a sectional view for illustrating that the preferred embodiment is to be connected with a connecting member;

FIG. 7 is a sectional view of the preferred embodiment for illustrating that the preferred embodiment is connected with the connecting member, such that engaging arms of the retaining module are in a locking state; and

FIG. 8 is a sectional view of the preferred embodiment for illustrating that the preferred embodiment is to be disengaged from the connecting member such that the engaging arms of the retaining module are in a release state.

### DETAILED DESCRIPTION OF THE PREFERRED EMBODIMENT

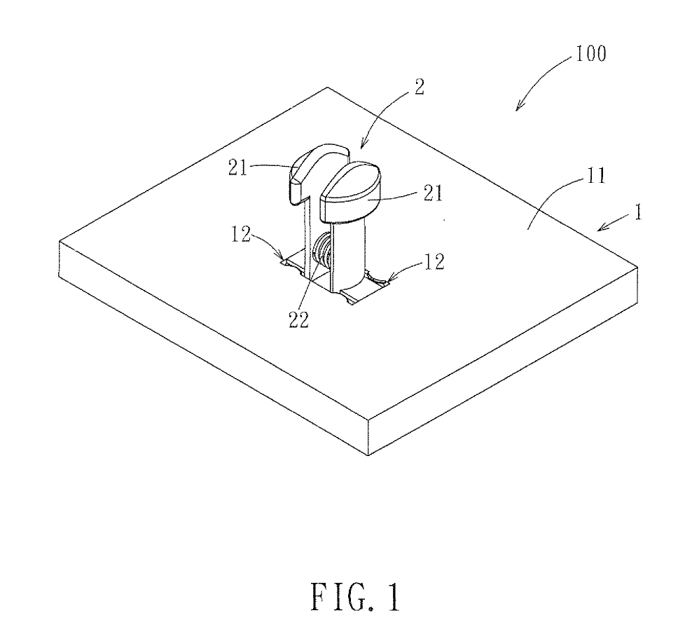

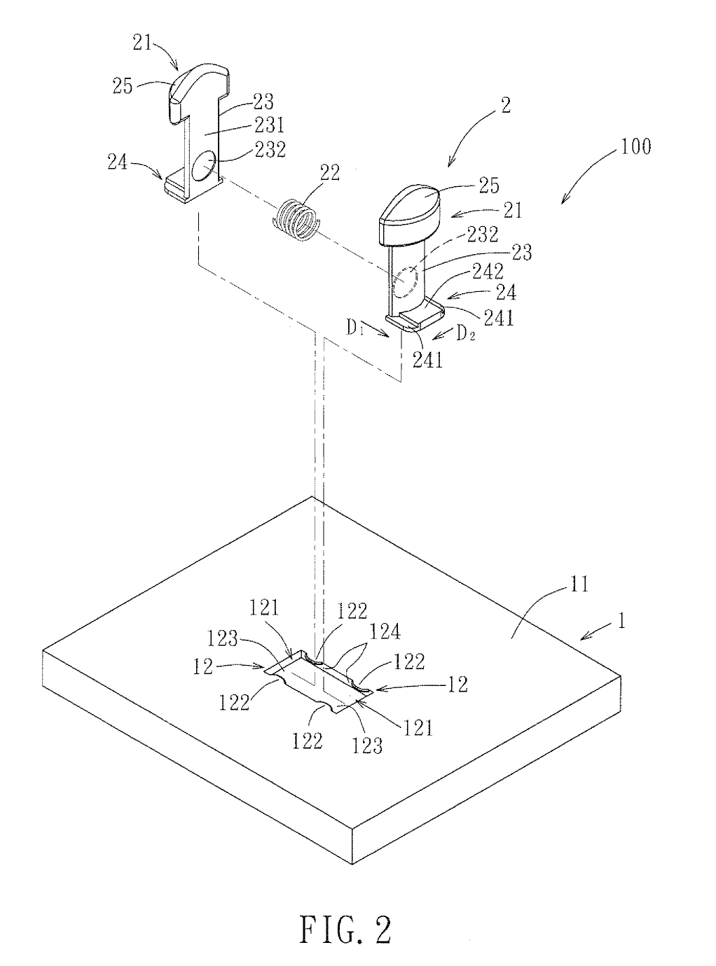

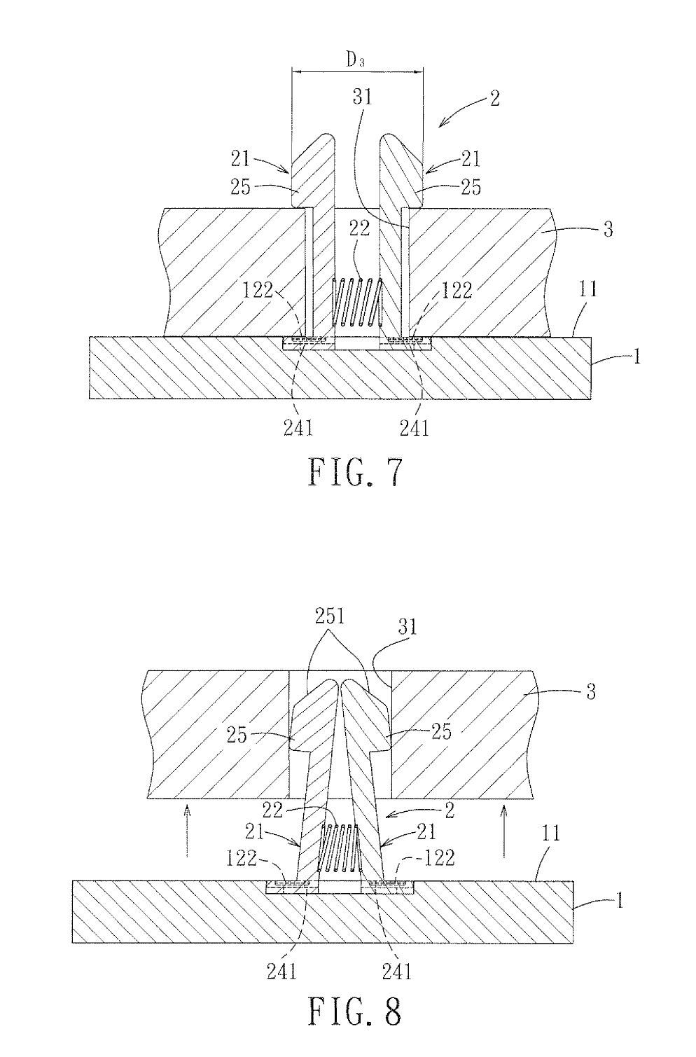

Referring to FIGS. 1 and 2, the preferred embodiment of a component assembly 100 according to the present invention is shown to include a component 1 and a retaining module 2. The component assembly 100 is adapted to connect with a connecting member 3 (as shown in FIG. 7) that has a hole 31 formed therethrough so as to be sleeved on the retaining module 2 to thereby connect with the component 1. In this embodiment, the component 1 is a housing of an electronic device, such as a computer and the connecting member 3 is a member to be coupled to the housing, such as a plate, a support frame, a circuit board, etc.

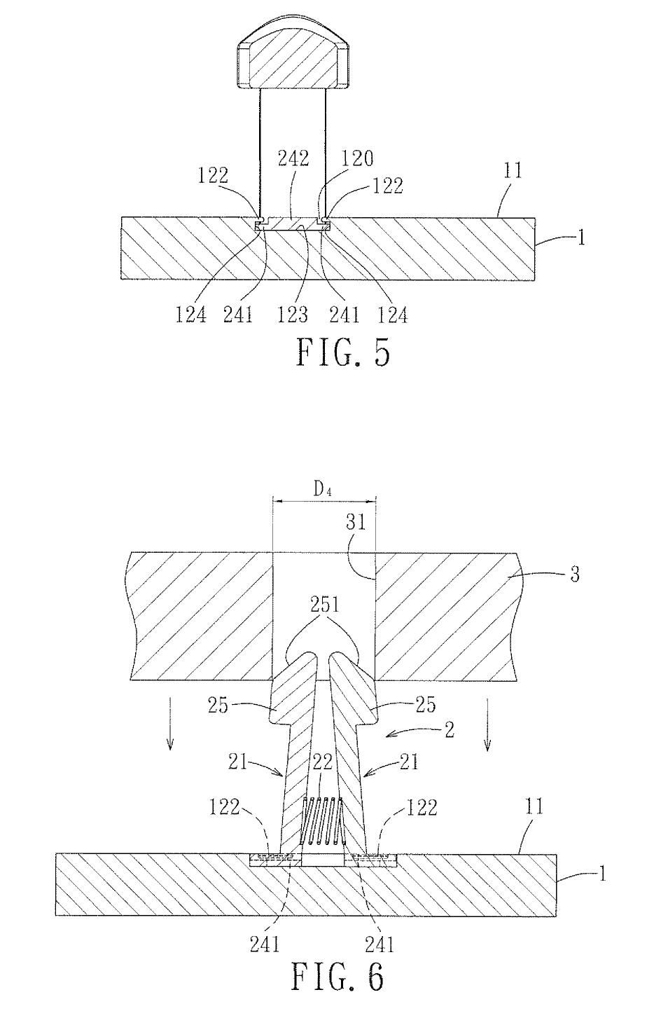

Referring to FIGS. 2, 3 and 5, the component 1 has a top surface 11 and a pair of first engaging portions 12 disposed at the top surface 11 of the component 1. In this embodiment, each of the first engaging portions 12 includes a recess 121 formed in the top surface 11, and two stop blocks 122 provided in the recess 121. The recess 121 of each of the first engaging portions 12 is defined by a groove bottom surface 123 disposed below the top surface 11 and two groove side surfaces 124 that are spaced apart from each other and that are connected to the groove bottom surface 123 and the top surface 11. The stop blocks 122 of each of the first engaging portions 12 are adjacent to the top surface 11, and extend respectively from the two groove side surfaces 124 toward each other to define a retaining groove 125 between the groove bottom surface 123 and the stop blocks 122. In this embodiment, the recesses 121 of the first engaging portions 12 are in spatial communication with each other, the groove bottom surfaces 123 of the first engaging portions 12 are connected to each other, and the groove side surfaces 124 of one of the first engaging portions 12 are connected respectively to the groove side surfaces 124 of the other one of the first engaging portions 12.

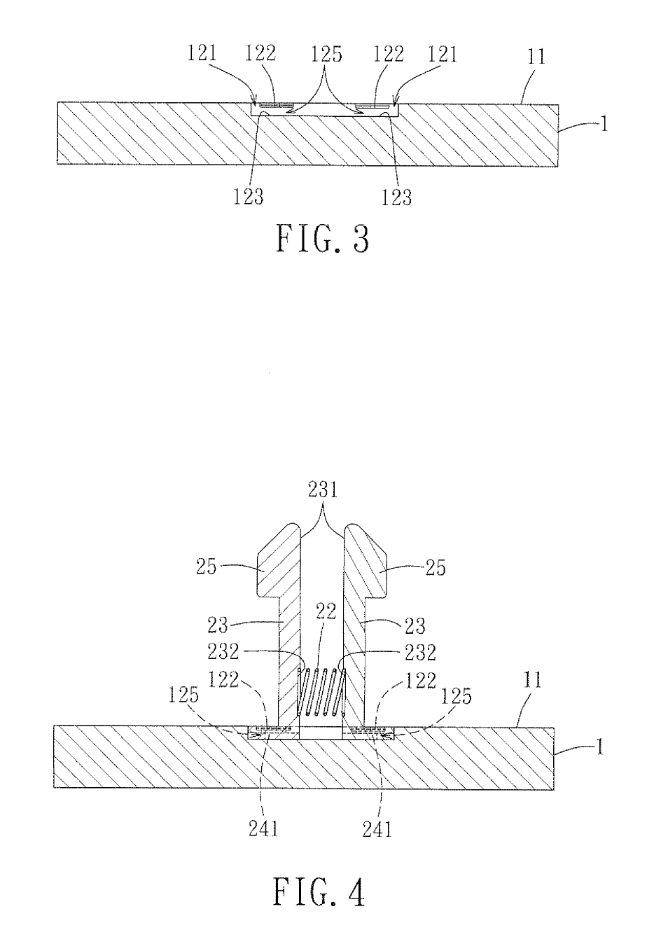

Referring to FIGS. 2 to 5, the retaining module 2 includes a pair of engaging arms 21 and a resilient member 22. Each of the engaging arms 21 has an upright elongate arm body 23, a second engaging portion 24 disposed at a bottom end of the arm body 23, and a head portion 25 disposed at a top end of the arm body 23. In this embodiment, the arm body 23 of each of the engaging arms 21 has an inner side surface 231 formed with a positioning groove 232.

The second engaging portion 24 of each of the engaging arms 21 is configured as a plate extending horizontally from the bottom end of the arm body 23 of the corresponding engaging arm 21 away from the inner side surface 231 of the corresponding engaging arm 21 in a first direction (D₁), such that the arm body 23 and the second engaging portion 24 of the corresponding engaging arm 21 are combined to form an L-shaped structure. The second engaging portion 24 of each of the engaging arms 21 is divided into two side plate portions 241 and a middle plate portion 242 arranged along a second direction (D₂) transverse to the first direction (D₁), such that the middle plate portion 242 is connected between the two side plate portions 241, and top surfaces of the two side plate portions 241 are below a top surface of the middle plate portion 242. The two side plate portions 241 and the middle plate portion 242 of each of the second engaging portions 24 have interconnected bottom surfaces. In other words, the middle plate portion 242 is thicker than the side plate portions 241, such that each of the second engaging portions 24 has an inverted T-shaped cross-section.

The head portion 25 of each of the engaging arms 21 protrudes laterally in a direction away from the corresponding inner side surface 231, and has a convex top surface 251.

The engaging arms 21 are positioned such that the inner side surfaces 231 face each other and the positioning grooves 232 are aligned with each other along the first direction (D₁). In this embodiment, the resilient member 22 is a compression spring having two ends that extend respectively into the positioning grooves 232 and that are fixed respectively in the positioning grooves 232, e.g., by glue.

By engaging the second engaging portions 24 of the two engaging arms 21 within the retaining grooves 125 of the two first engaging portions 12, respectively, the retaining module 2 is connected to the component 1 in such a manner that the arm bodies 23 are upright. In more details, when the second engaging portion 24 of each of the engaging arms 21 is extended into the retaining groove 125 of the corresponding first engaging portion 12, the two side plate portions 241 of each of the second engaging portions 24 are disposed between the corresponding groove bottom surface 123 and the corresponding two stop blocks 122, and the middle plate portion 242 are extended between the two stop blocks 122 (i.e., are disposed in a space 120 between the two stop blocks 122).

Since the retaining grooves 125 of the two first engaging portions 12 are in spatial communication with each other, as described above, to connect the retaining module 2 to the component 1, the engaging arms 21 are pressed toward each other to compress the resilient member 22. Next, the second engaging portion 24 of one of the engaging arms 21 is extended into the retaining groove 125 of one of the first engaging portions 12 through a space disposed between the two first engaging portions 12. Thereafter, the second engaging portion 24 of the other one of the engaging arms 21 is extended into the retaining groove 125 of the other one of the first engaging portions 12. Finally, the engaging arms 21 are released so that the resilient member 22 biases the engaging arms 21 to move away from each other, thereby preventing removal of the retaining module 2 from the component 1.

When the retaining module 2 is deformed, broken or fractured so that replacement thereof is required, the engaging arms 21 are first pressed toward each other to compress the resilient member 22. Next, the second engaging portion 24 of one of the engaging arms 21 is removed from one of the first engaging portions 12. Subsequently, the second engaging portion 24 of the other one of the engaging arms 21 is removed from the other one of the first engaging portions 12.

Referring to FIGS. 6 to 8, The engaging arms 21 extend through the hole 31 in the connecting member 3, and are convertible between a locking state, where the connecting member 3 is confined between the component 1 and the head portions 25 of the engaging arms 21, and a release state, where the head portions 25 of the engaging arms 21 are movable through the hole 31 in the connecting member 3 and where removal of the head portions 25 from the connecting member 3 is allowed.

When the retaining module 2 is coupled to the component 1, and when the resilient member 22 is not compressed, the distance (D₃) (as shown in FIG. 7) between outer lateral sides of the head portions 25 of the engaging arms 21 is larger than the diameter (D₄) (as shown in FIG. 6) of the hole 31 of the connecting member 3. As such, during a progress for sleeving the connecting member 3 on the retaining module 2, an inner wall surface defining the hole 31 is moved into contact with the convex top surfaces 251 of the head portions 25. Subsequently, when the connecting member 3 is moved downward, because of the guidance of the convex top surface 251, the two engaging arms 21 are pressed toward each other to thereby compress the resilient member 22. As soon as the connecting member 3 moves past the head portions 25 of the engaging arms 21, the two engaging arms 21 are restored to their original relative positions by the restorative force of the resilient member 22. In such a manner, the connecting member 3 is confined between the component 1 and the head portions 25 of the two engaging arms 21, such that the connecting member 3 is sleeved on the retaining module 2. At this moment, the engaging arms 21 are in the locking state. As such, the convex top surface 251 can facilitate insertion of the head portion 25 through the hole 31.

Referring to FIG. 8, to remove the connecting member 3 from the component 1, the head portions 25 of the engaging arms 21 that extend out of the hole 31 are first pressed toward each other. Next, the connecting member 3 is moved upwardly to pass past the head portions 25 of the engaging arms 21. During movement of the head portions 25 within the hole 31, the engaging arms 21 are in the release state.

It should be noted herein that, in this embodiment, the first and second engaging portions 12, 24 are but not limited to retaining grooves and plates. For example, an assembly of the first and second engaging portions 12, 24 may be a hook-and-groove or tongue-and-hole arrangement.

In view of the above, the connecting member 3 is connected to the component 1 by the retaining module 2. When damage is caused to the retaining module 2 to an extent that the retaining module 2 is not reusable, all that is needed for replacement is only the retaining module 2. In other words, it is not necessary to replace the connecting member 3 and the component 1, thereby reducing the replacement cost significantly. Thus, the object of this invention is achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A retaining module adapted for connection with a component and adapted to permit a connecting member to be sleeved thereon, so as to connect the connecting member to the component, the connecting member having a hole formed therethrough, the component having a pair of first engaging portions, said retaining module comprising:
a pair of engaging arms each having an upright elongate arm body, a second engaging portion disposed at a bottom end of said arm body, and a head portion disposed at a top end of said arm body, said second engaging portions of said engaging arms being adapted to engage respectively the first engaging portions of the component so as to connect said engaging arms with the component, said engaging arms being adapted to extend through the hole in the connecting member and being convertible between a locking state, where the connecting member is confined between the component and said head portions of said engaging arms, and a release state, where said head portions of said engaging arms are movable through the hole in the connecting member and where removal of said retaining module from the connecting member is allowed; and
a resilient Member disposed between said engaging arms for biasing said engaging arms into said locking state.

2. The retaining module as claimed in claim 1, each of the first engaging portions defining a retaining groove, wherein each of said second engaging portions is configured as a plate extending horizontally from said bottom end of said arm body of a corresponding one of said engaging arms and adapted to engage the retaining groove defined by a corresponding one of said first engaging portions of the component.

3. The retaining module as claimed in claim 2, each of the first engaging portions including a recess defined by a groove bottom surface and two groove side surfaces connected to the groove bottom surface, and two stop blocks extending respectively from the groove side surfaces toward each other to define the retaining groove between the groove bottom surface and the stop blocks, wherein each of said second engaging portions has two side plate portions each adapted to be disposed between the groove bottom surface and a corresponding one of the stop blocks of a corresponding one of the first engaging portions, and a middle plate portion connected between said side plate portions and adapted to extend within a space between the stop blocks of the corresponding one of the first engaging portions.

4. The retaining module as claimed in claim 3, wherein each of said head portions of said engaging arms has a convex top surface adapted for facilitating insertion of a corresponding one of said head portions through the hole in the connecting member.

5. The retaining module as claimed in claim 4, wherein said arm body of each of said engaging arms has an inner side surface formed with a positioning groove, said inner side surfaces of said arm bodies of said engaging arms facing each other, said positioning grooves of said engaging arms being aligned with each other, said resilient member being configured as a compression spring and having two opposite ends extending respectively into said positioning grooves.

6. A component assembly adapted to connect with a connecting member, the connecting member having a hole formed therethrough so as to be sleeved on said component assembly, said component assembly comprising:
a component has a surface, and a pair of first engaging portions disposed at said surface of said component; and
a retaining module that includes
a pair of engaging arms each having an upright elongate arm body, a second engaging portion disposed at a bottom end of said arm body, and a head portion disposed at a top end of said arm body, said second engaging portions of said engaging arms engaging respectively said first engaging portions of said component so as to connect said engaging arms with said component, said engaging arms being adapted to extend through the hole in the connecting member and being convertible between a locking state, where the connecting member is confined between said component and said head portions of said engaging arms, and a release state, where said head portions of said engaging arms are movable through the hole in the connecting member and where removal of said head portions from the connecting member is allowed, and
a resilient member disposed between said engaging arms for biasing said engaging arms into said locking state.

7. The component assembly as claimed in claim 6, wherein each of said first engaging portions defines a retaining groove, and each of said second engaging portions is configured as a plate extending horizontally from said bottom end of said arm body of a corresponding one of said engaging arms to engage said retaining groove defined by a corresponding one of said first engaging portions of said component.

8. The component assembly as claimed in claim 7, wherein each of said first engaging portions includes a recess defined by a groove bottom surface and two groove side surfaces connected to said groove bottom surface, and two stop blocks extending respectively from said groove side surfaces toward each other to define said retaining groove between said groove bottom surface and said stop blocks.

9. The component assembly as claimed in claim 8, wherein each of said second engaging portions has two side plate portions each disposed between said groove bottom surface and a corresponding one of said stop blocks of a corresponding one of said first engaging portions, and a middle plate portion connected between said side plate portions and extending within a space between said stop blocks of the corresponding one of said first engaging portions.

10. The component assembly as claimed in claim 9, wherein said retaining grooves of said first engaging portions are in spatial communication with each other.

11. The component assembly as claimed in claim 10, wherein each of said head portions of said engaging arms has a convex top surface adapted for facilitating insertion of a corresponding one of said head portions through the hole in the connecting member.

12. The component assembly as claimed in claim 11, wherein said arm body of each of said engaging arms has an inner side surface formed with a positioning groove, said inner side surfaces of said arm bodies of said engaging arms facing each other, said positioning grooves of said engaging arms being aligned with each other, said resilient member being configured as a compression spring and having two opposite ends extending respectively into said positioning grooves.
